(19) United States
(12) Patent Application Publication
(10) Pub. No.: US 2023/0182341 A1
(43) Pub. Date: Jun. 15, 2023

(54) WATER JET SPLITTING MACHINE FOR WASTE TIRES

(71) Applicant: ECOFORTUNE RENEWABLE ENERGY CO., LTD., TAIPEI CITY (TW)

(72) Inventors: HSIEN CHING HUANG, Taichung City (TW); YUNG CHUAN CHEN, Taipei City (TW); CHEN CHENG HUANG, Taipei City (TW)

(21) Appl. No.: 17/643,491

(22) Filed: Dec. 9, 2021

(51) Int. Cl. B26F 3/00; B26D 3/00

(52) U.S. Cl. CPC B26F 3/004; B26D 3/005

(57) ABSTRACT

A water jet splitting machine for waste tires includes a feeding device, a water jet splitting chamber, a waste tire controlling device, a water jet device, and a discharging device. The water jet splitting chamber is disposed beside the feeding device. The waste tire controlling device is disposed on a top of the water jet splitting chamber and has a central line and a claw assembly. The claw assembly is disposed in the water jet splitting chamber and has at least three claw mechanisms. Each one of the at least three claw mechanisms has a claw capable of moving away from the central line along a radial direction. The water jet device is disposed beside the claw assembly of the waste tire controlling device and has a water jet seat having at least one water jet head. The discharging device is disposed beside the water jet splitting chamber.

### BACKGROUND OF THE INVENTION

### 1. Field of the Invention

The present invention relates to a waste processing device, and more particularly to a water jet splitting machine for waste tires.

### 2. Description of Related Art

In the past, waste tires were processed mainly by burning. During tire combustion, air pollutants such as dioxin, nitrogen oxides, and sulfur oxides are emitted into the air. In a modern society with rising environmental awareness, all countries are raising the emission standards for hazardous air pollutants. However, billions of waste tires around the world are produced every year, costing a lot to process the waste tires.

To cope with the waste-tire problem, methods and machines are proposed to reuse and recycle the waste tires. One of the methods is to process the waste tires by mechanical crushing with a conventional water jet splitting machine for waste tires. The conventional water jet splitting machine for waste tires splits the waste tires by ejecting water at a high speed to the waste tires, such that rubber layers of the waste tires are cut down. The rubber layers can be collected and reused.

However, users have to put waste tires into a water jet splitting chamber of the conventional water jet splitting machine for waste tires in person. The conventional water jet splitting machine for waste tires is low in automation, which lowers the efficiency in processing the waste tires. Further to that, safety of the users are in doubt since the users have to stretch their hands into the conventional water jet splitting machine for waste tires.

To overcome the shortcomings of the conventional water jet splitting machine for waste tires, the present invention tends to provide a water jet splitting machine for waste tires to mitigate or obviate the aforementioned problems.

### SUMMARY OF THE INVENTION

The main objective of the present invention is to provide a water jet splitting machine for waste tires. The water jet splitting machine for waste tires is utilized to split at least one waste tire, and the water jet splitting machine for waste tires includes a feeding device, a water jet splitting chamber, a waste tire controlling device, a water jet device, and a discharging device.

The water jet splitting chamber is disposed beside the feeding device. The waste tire controlling device is disposed on a top of the water jet splitting chamber and has a central line and a claw assembly. The claw assembly is disposed in the water jet splitting chamber and has at least three claw mechanisms. Each one of the at least three claw mechanisms has a claw capable of moving away from the central line along a radial direction, such that the claws of the at least three claw mechanisms support an inner periphery of the at least one waste tire together. The water jet device is disposed beside the claw assembly of the waste tire controlling device and has a water jet seat. The water jet seat has at least one water jet head capable of ejecting water toward the at least one waste tire. The discharging device is disposed at one of two sides of the water jet splitting chamber away from the feeding device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a water jet splitting machine for waste tires in accordance with the present invention;

FIG. 2 is a top side view of the water jet splitting machine for waste tires in FIG. 1;

FIG. 3 is an enlarged cross-sectional side view of the water jet splitting machine for waste tires in FIG. 1;

FIG. 4 is a perspective view in partial section of a waste tire controlling device of the water jet splitting machine for waste tires in FIG. 1;

FIG. 5 is a side view in partial section of a claw assembly of the waste tire controlling device in FIG. 4;

FIG. 6 is a perspective view of a water jet device of the water jet splitting machine for waste tires in FIG. 1;

FIG. 6A is an enlarged perspective view of a tread sensing rod and a compression spring of the water jet device of the water jet splitting machine for waste tires in FIG. 1;

FIG. 7 is an enlarged front side view of the water jet device in FIG. 6;

FIG. 8 is a circuit block diagram of the water jet splitting machine for waste tires in FIG. 1;

FIGS. 9 to 12 are operational cross-sectional side views of the water jet splitting machine for waste tires in FIG. 1;

FIG. 11A is an enlarged side view of the water jet device of the water jet splitting machine for waste tires in FIG. 1;

FIG. 12A is an enlarged operational side view of the water jet device of the water jet splitting machine for waste tires in FIG. 1;

FIG. 13 is an operational top side view of the water jet splitting machine for waste tires in FIGS. 1; and

FIG. 14 is an operational side view of the water jet splitting machine for waste tires in FIG. 1;

### DETAILED DESCRIPTION OF THE PREFERRED EMBODIMENT

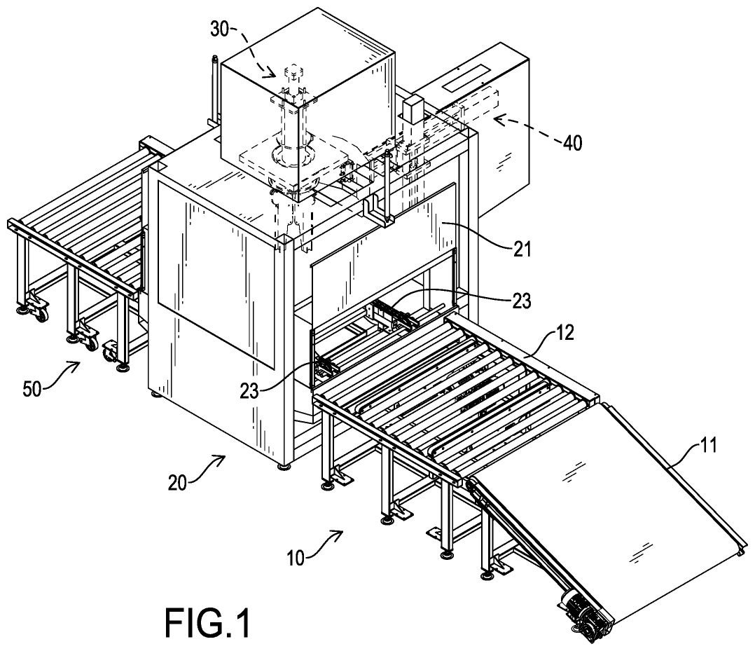

With reference to FIGS. 1, 2, and 13, a water jet splitting machine for waste tires in accordance with the present invention is utilized to split at least one waste tire 70, and includes a feeding device 10, a water jet splitting chamber 20, a waste tire controlling device 30, a water jet device 40, a discharging device 50, and a control console 60.

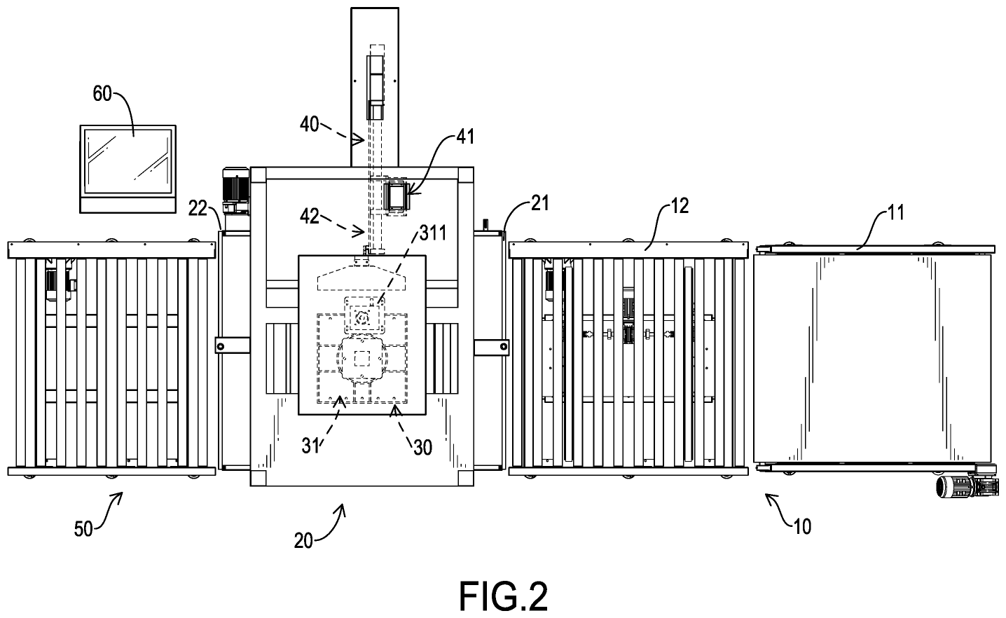

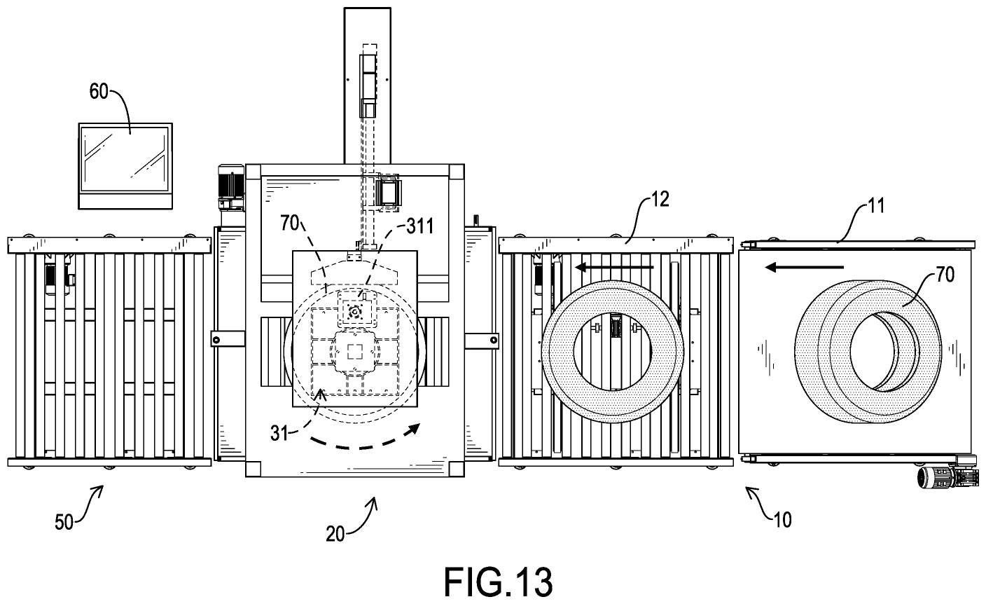

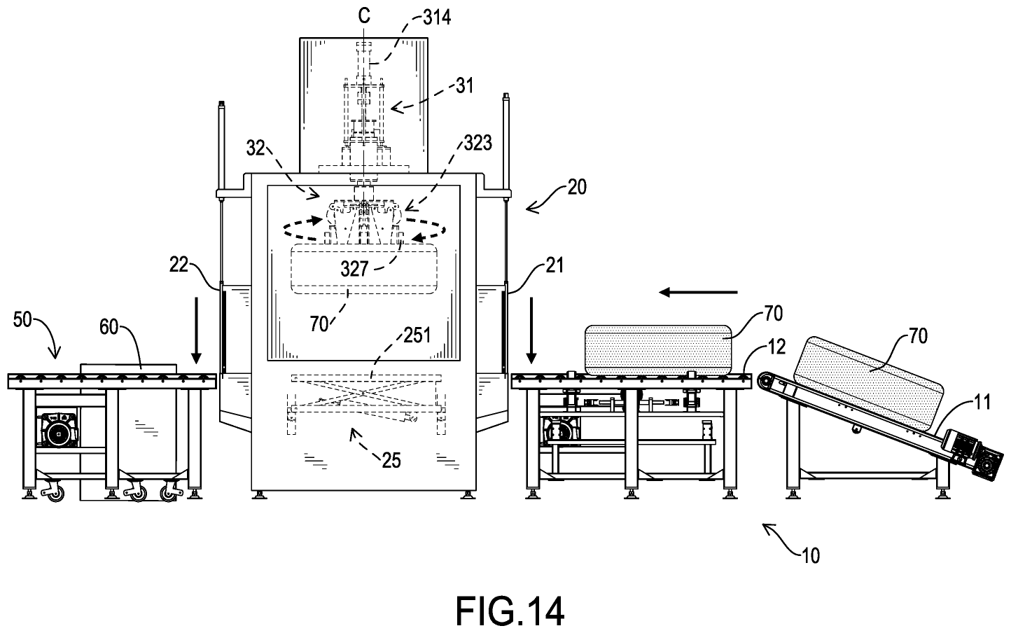

With reference to FIGS. 1 and 2, the feeding device 10 has an inclined conveyor 11 and a horizontal conveyor 12. The horizontal conveyor 12 is disposed adjacent to the inclined conveyor 11, and the inclined conveyor 11 is capable of transporting the at least one waste tire 70 from a position adjacent to a ground to the horizontal conveyor 12 as shown in FIGS. 13 and 14. In the present invention, the inclined conveyor 11 is a belt conveyor.

With reference to FIGS. 1 to 3, the water jet splitting chamber 20 is disposed beside the feeding device 10, is located at a side of the horizontal conveyor 12 away from the inclined conveyor 11, and has a front door 21, a back door 22, two conveyors 23, a receiving funnel 24, and a lifting apparatus 25. The front door 21 is liftably mounted to the water jet splitting chamber 20, and is disposed at one of two sides of the water jet splitting chamber 20 adjacent to the horizontal conveyor 12 of the feeding device 10. The back door 22 is liftably mounted to the water jet splitting chamber 20, and is disposed at the other one of the two sides of the water jet splitting chamber 20 away from the front door 21. When both the front door 21 and the back door 22 move downwardly, the water jet splitting chamber 20 is in a closed state.

The two conveyors 23 are disposed in the water jet splitting chamber 20 at a spaced interval, and each one of the two conveyors 23 extends from the front door 21 toward the back door 22. A height of each one of the two conveyors 23 is close to a height of the horizontal conveyor 12, such that the horizontal conveyor 12 can transport the at least one waste tire 70 to the two conveyors 23. Thereby, the at least one waste tire 70 is transported into the water jet splitting chamber 20. In the present invention, each one of the two conveyors 23 is a chain, so a friction between said conveyor 23 and the at least one waste tire 70 is increased. In this way, the at least one waste tire 70 will not move relative to the two conveyors 23 during the transportation.

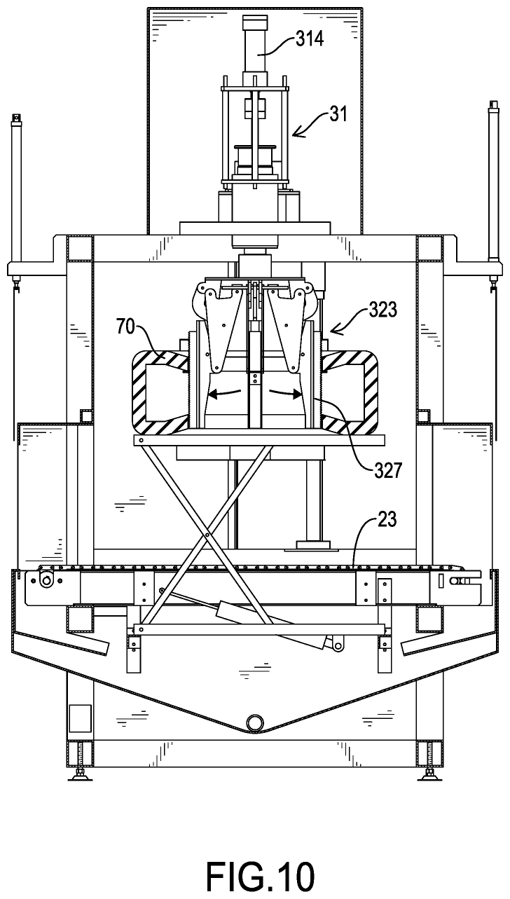

The receiving funnel 24 is disposed at a lower part of the water jet splitting chamber 20, and is located below the two conveyors 23. The receiving funnel 24 tapers off from a top portion thereof toward a bottom portion thereof and has a discharge tube 241. The discharge tube 241 communicates with the receiving funnel 24 and extends out of the water jet splitting chamber 20. The lifting apparatus 25 is disposed in the water jet splitting chamber 20, is located above the receiving funnel 24, is located between the two conveyors 23, and has a platform 251. The platform 251 is disposed on a top of the lifting apparatus 25 and is used to place the at least one waste tire 70. The lifting apparatus 25 can lift the at least one waste tire 70 as shown in FIG. 9. The structure and how the lifting apparatus 25 works are conventional, so detailed descriptions thereof are omitted.

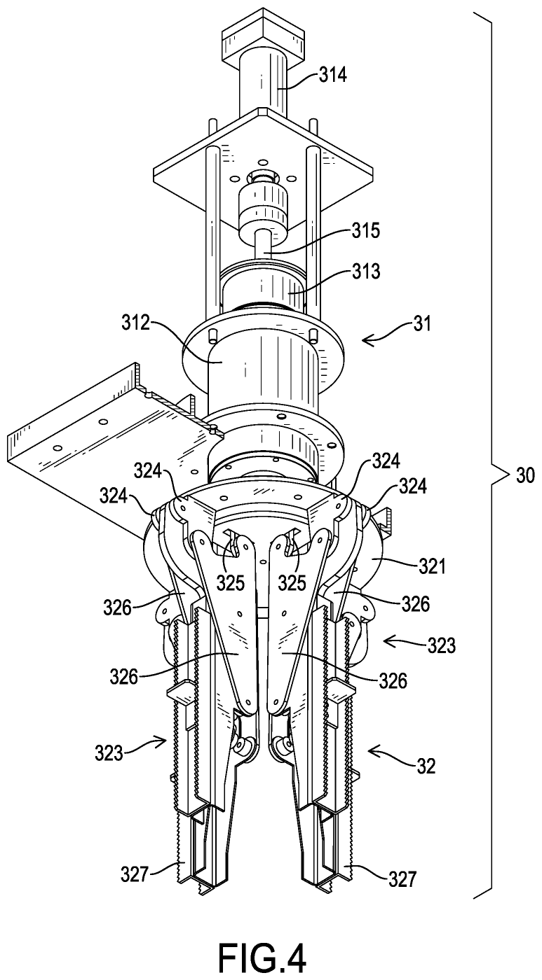

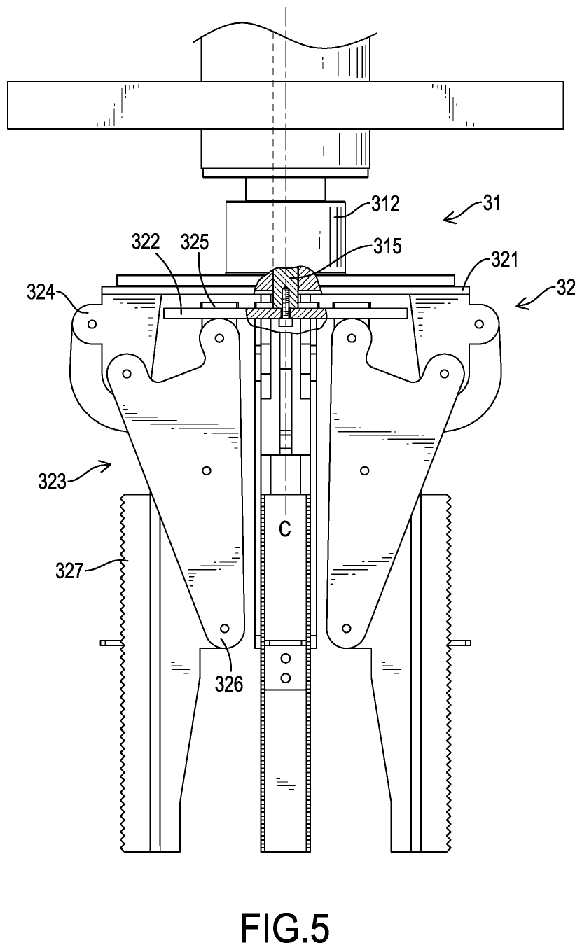

With reference to FIGS. 2 to 4, the waste tire controlling device 30 is disposed on a top of the water jet splitting chamber 20 and has a driving assembly 31 and a claw assembly 32. The driving assembly 31 is mounted on the top of the water jet splitting chamber 20 and has a driver 311, a shaft 312, a drive pulley 313, a cylinder 314, and a pushing rod 315. The driver 311 is mounted on the top of the water jet splitting chamber 20. The shaft 312 is mounted on the top of the water jet splitting chamber 20, is spaced apart from the driver 311, and extends into the water jet splitting chamber 20. The drive pulley 313 is disposed on a top of the shaft 312. In the present invention, the drive pulley 313 is a tooth sprocket. The driver 311 and the tooth sprocket are connected via a chain, such that power is transmitted from the driver 311 to the drive pulley 313, which is the tooth sprocket, and the drive pulley 313 is driven to rotate. The drive pulley 313 can drive all the components in the driving assembly 31 to rotate except for the driver 311. The cylinder 314 is located above the drive pulley 313 and is spaced apart from the drive pulley 313. The pushing rod 315 is located below the cylinder 314, abuts against a piston rod of the cylinder 314, and sequentially extends into the drive pulley 313, the shaft 312, and the water jet splitting chamber 20. With reference to FIG. 5, the pushing rod 315 has a central line C extending along a longitudinal direction of the pushing rod 315.

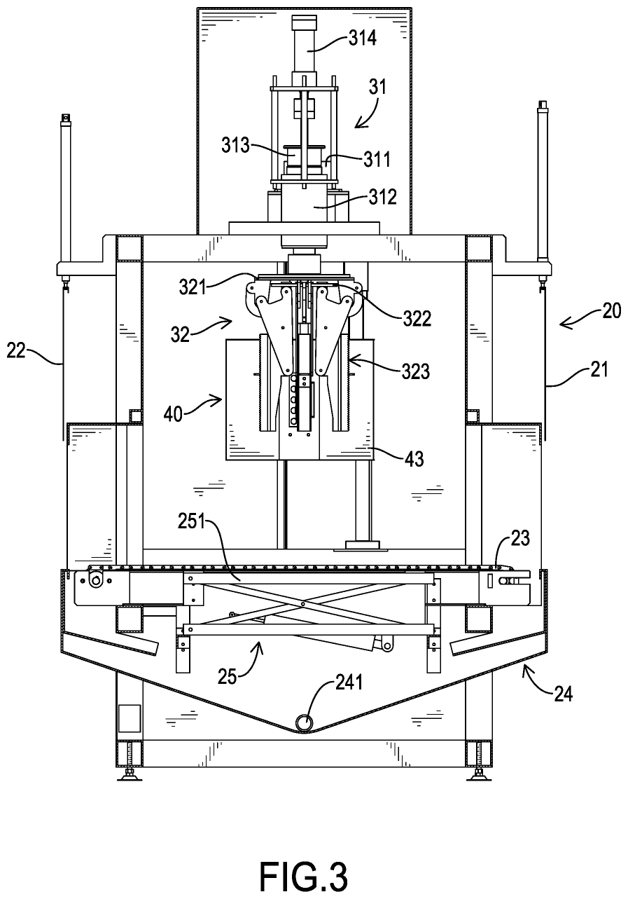

With reference to FIGS. 3 to 5, the claw assembly 32 is disposed in the water jet splitting chamber 20, and has a connecting flange 321, a supporting plate 322, and at least three claw mechanisms 323. The connecting flange 321 is disposed below the shaft 312 of the driving assembly 31. The supporting plate 322 is located below the connecting flange 321. The pushing rod 315 extends through the connecting flange 321 and is mounted to the supporting plate 322. The at least three claw mechanisms 323 are mounted to the connecting flange 321 and the supporting plate 322 and are spaced apart from one another. Each one of the at least three claw mechanisms 323 has two first fixing portions 324, two second fixing portions 325, two linkage arms 326 and a claw 327. The two first fixing portions 324 are disposed on a bottom surface of the connecting flange 321 at a spaced interval. The two second fixing portions 325 are disposed on the supporting plate 322 at a spaced interval. Each one of the two second fixing portions 325 is aligned with a respective one of the two first fixing portions 324. Each one of the two linkage arms 326 is pivotally connected to a respective one of the two first fixing portions 324 and a respective one of the two second fixing portions 325 aligned with said first fixing portion and abuts against the supporting plate 322. The claw 327 is mounted between the two linkage arms 326.

With reference to FIGS. 3 to 5, when the piston rod of the cylinder 314 extends out of the cylinder 314 downwardly, the piston rod pushes the pushing rod 315, such that the pushing rod 315 pushes the supporting plate 322 downwardly. Pushed by the supporting plate 322, the two linkage arms 326 of said claw mechanism 323 pivot relative to the two first fixing portions 324 and the two second fixing portions 325 and make the claw 327 pivot away from the central line C of the pushing rod 315 along a radial direction of the pushing rod 315 outwardly. In this way, the claws 327 of the at least three claw mechanisms 323 support an inner periphery of the at least one waste tire 70 as shown in FIG. 10.

With reference to FIGS. 2, 3, and 6, the water jet device 40 is disposed beside the claw assembly 32 of the waste tire controlling device 30 and has a linear moving device 41, a connecting base 48, a linear displacement device 42, a water baffle 43, a water jet seat 44, a tread sensing rod 45, a compression spring 46, and a micro switch 47. The linear moving device 41 is fixed in the water jet splitting chamber 20, and is disposed beside the claw assembly 32. The connecting base 48 is mounted to the linear moving device 41. The linear displacement device 42 is mounted to the connecting base 48, and is disposed beside the claw assembly 32. The connecting base 48 and the linear displacement device 42 can be driven by the linear moving device 41 and move upwardly and downwardly. The water baffle 43 is mounted to the linear displacement device 42, and the water baffle 43 can be driven by the linear displacement device 42 and moves toward or away from the claw assembly 32.

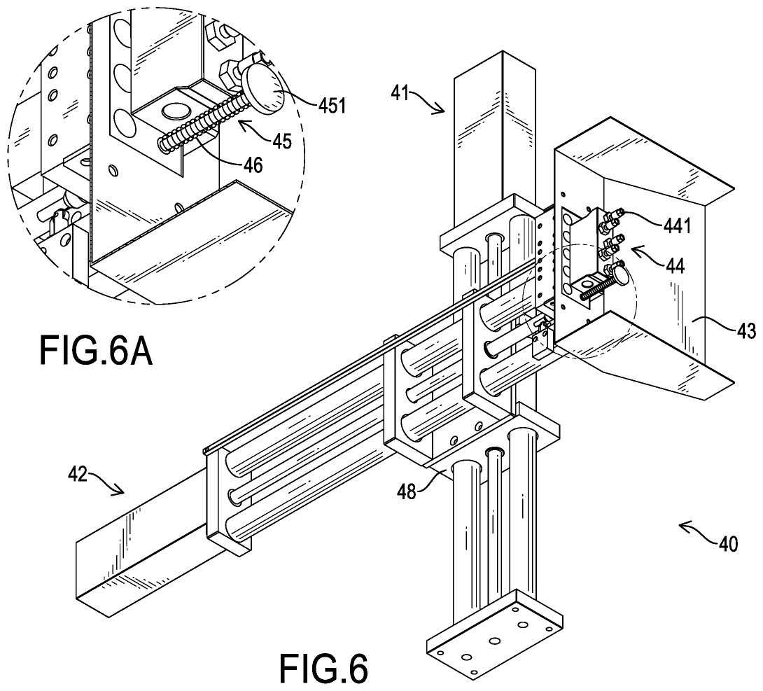

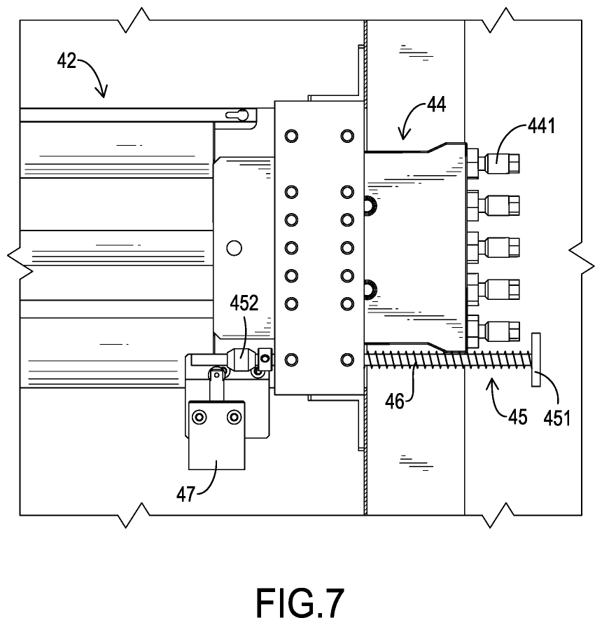

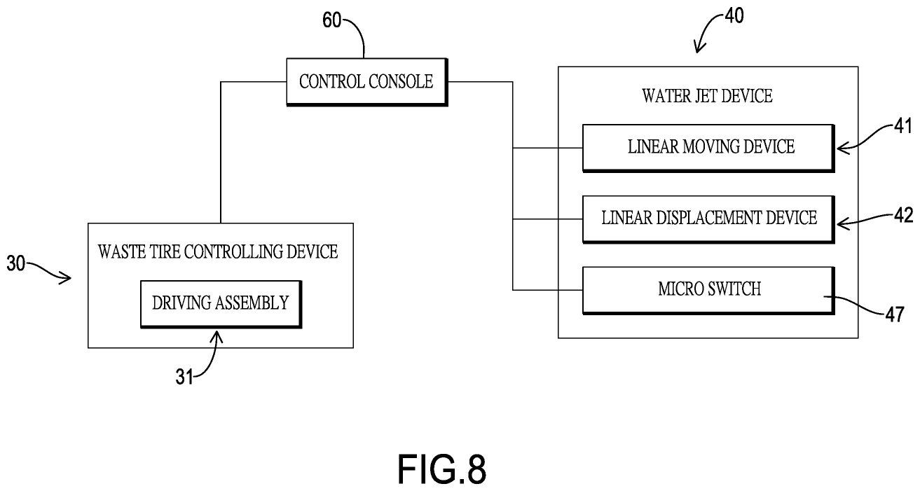

With reference to FIGS. 6, 7, and 12, the water jet seat 44 is mounted on the water baffle 43, is connected to the linear displacement device 42 indirectly, and has at least one water jet head 441 extending toward the claw assembly 32. In the present invention, the water jet seat 44 has multiple water jet heads 441. The multiple water jet heads 441 are disposed on the water jet seat 44 and are disposed at spaced intervals along a vertical direction of the water jet seat 44. The tread sensing rod 45 is disposed below the water jet seat 44 and is movably mounted to the water baffle 43. In such a configuration, the tread sensing rod 45 can move toward or away from the claw assembly 32. The tread sensing rod 45 is indirectly connected to the linear displacement device 42, and has an abutting portion 451 and a cam 452.

The abutting portion 451 is disposed at one of two ends of the tread sensing rod 45 adjacent to the claw assembly 32 and extends farther than the at least one water jet head 441. The cam 452 protrudes on an outer surface of the tread sensing rod 45 radially, is disposed away from the claw assembly 32, and is disposed between the two ends of the tread sensing rod 45. The cam 452 and the abutting portion 451 are respectively located on two sides of the water baffle 43. The compression spring 46 surrounds the tread sensing rod 45 and has two ends. One of the two ends of the compression spring 46 abuts against the water baffle 43, and the other one of the two ends of the compression spring 46 abuts against the abutting portion 451 of the tread sensing rod 45.

The micro switch 47 is connected to the water baffle 43, is indirectly connected to the linear displacement device 42, and is adjacent to the cam 452 of the tread sensing rod 45. When the abutting portion 451 of the tread sensing rod 45 is pushed and the tread sensing rod 45 moves away from the claw assembly 32, the cam 452 contacts the micro switch 47, and then the micro switch 47 emits a signal making the linear displacement device 42 move the water baffle 43 away from the claw assembly 32.

With reference to FIGS. 1 and 2, the discharging device 50 is disposed at one of the two sides of the water jet splitting chamber 20 away from the feeding device 10, and is disposed adjacent to the back door 22 of the water jet splitting chamber 20. A height of the discharging device 50 is close to the height of each one of the two conveyors 23, such that the two conveyors 23 can transport the at least one waste tire 70 to the discharging device 50, and the at least one waste tire 70 is transported out of the water jet splitting chamber 20.

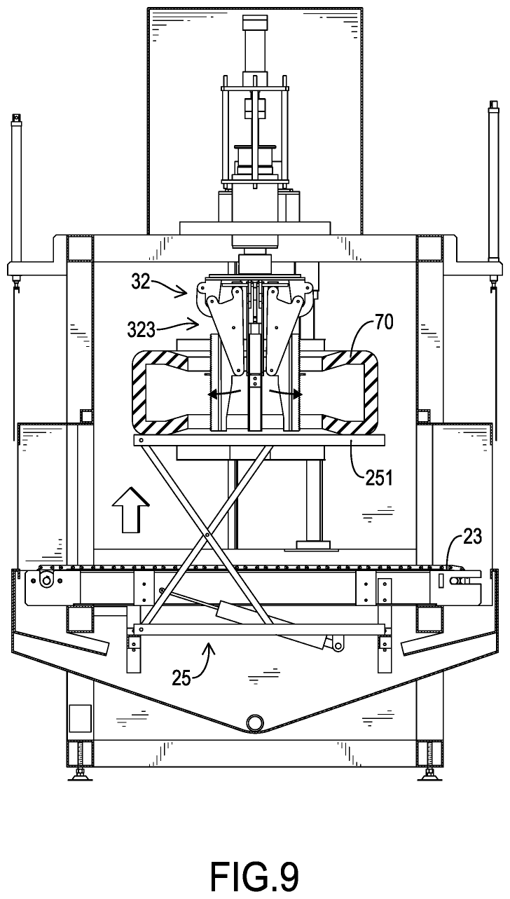

With reference to FIGS. 2 and 8, the control console 60 is located beside the discharging device 50, and the control console 60 is electrically connected to the driving assembly 31 of the waste tire controlling device 30, the linear moving device 41, the linear displacement device 42, and the micro switch 47. A user can input size data of the at least one waste tire 70 such as an inner diameter, an outer diameter, or a thickness of the at least one waste tire 70 into the control console 60.

With reference to FIGS. 1 and 2, when in use, input size data of the at least one waste tire 70 such as the inner diameter, the outer diameter, or the thickness of the at least one waste tire 70 into the control console 60, and then place the at least one waste tire 70 onto the inclined conveyor 11 of the feeding device 10. The at least one waste tire 70 is then transported onto the two conveyors 23 of the water jet splitting chamber 20 via the inclined conveyor 11 and the horizontal conveyor 12 sequentially. With reference to FIG. 9, the platform 251 of the lifting apparatus 25 ascends to a height enabling the at least three claw mechanisms 323 of the claw assembly 32 to extend into the at least one waste tire 70 originally placed on the two conveyors 23. With reference to FIG. 10, next, the piston rod of the cylinder 314 extends out of the cylinder 314 to an extent enabling the claws 327 of the at least three claw mechanisms 323 to support the inner periphery of the at least one waste tire 70 together according to the inner diameter of the at least one waste tire 70 inputted by the user. The platform 251 of the lifting apparatus 25 descends as soon as the at least one waste tire 70 is supported by the claw assembly 32.

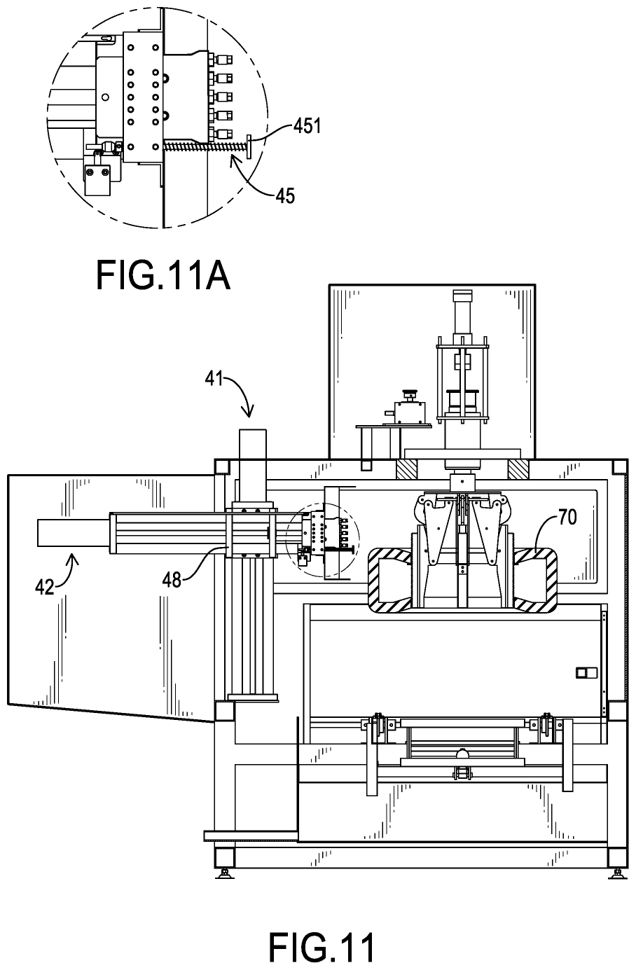

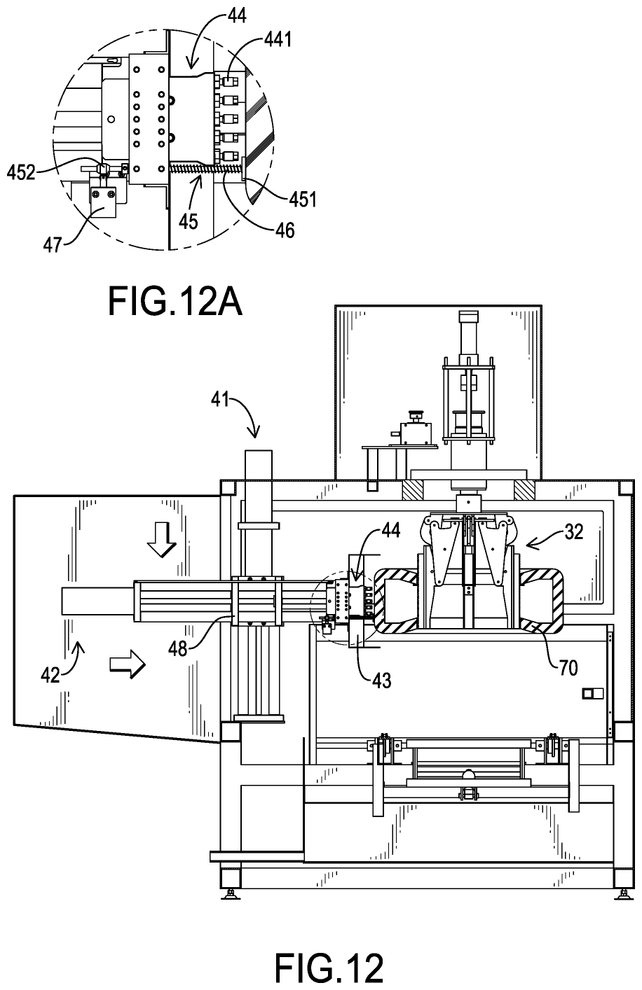

With reference to FIGS. 11 and 12, the linear moving device 41 moves the connecting base 48 and the linear displacement device 42 downwardly to a position where the water jet seat 44 aims at a center of the at least one waste tire 70 according to the thickness of the at least one waste tire 70 inputted by the user. The linear displacement device 42 moves the water baffle 43 to a position adjacent to an outer periphery of the at least one waste tire 70 according to the outer diameter of the at least one waste tire 70 inputted by the user. Simultaneously, the water jet seat 44 and the tread sensing rod 45 are both moved toward the at least one waste tire 70 until the abutting portion 451 of the tread sensing rod 45 is pushed by the at least one waste tire 70, such that the tread sensing rod 45 moves away from the at least one waste tire 70. Pushed by the abutting portion 451 of the tread sensing rod 45, the compression spring 46 is compressed.

In the meanwhile, with reference to FIG. 12, the cam 452 contacts the micro switch 47, and then the micro switch 47 emits the signal making the linear displacement device 42 move the water baffle 43 away from the at least one waste tire 70. In this way, the at least one water jet head 441 of the water jet seat 44 will not break due to friction between the at least one water jet head 441 and the at least one waste tire 70. After the abutting portion 451 of the tread sensing rod 45 leaves the at least one waste tire 70 and is spaced apart from the at least one waste tire 70, the compression spring 46 restores to its original length and pushes the abutting portion 451 of the tread sensing rod 45 to make the tread sensing rod 45 move back to its original position.

With reference to FIGS. 13 and 14, after the at least one waste tire 70 is positioned, both the front door 21 and the back door 22 descend to make the water jet splitting chamber 20 into a closed state. The driver 311 of the driving assembly 31 drives the drive pulley 313 to rotate, and the claw assembly 32 and the at least one waste tire 70 rotate along with the drive pulley 313. At this time, the at least one water jet head 441 of the water jet seat 44 ejects water at high speed toward the at least one waste tire 70, such that a rubber layer on the at least one waste tire 70 can be cut down. The rubber layer then falls into the receiving funnel 24 and is discharged out of the water jet splitting chamber 20 via the discharge tube 241.

When the at least one waste tire 70 has a protrusion disposed on its outer periphery and the protrusion pushes the abutting portion 451 of the tread sensing rod 45 during the ejection, the cam 452 contacts the micro switch 47, and then the micro switch 47 emits the signal making the linear displacement device 42 move the water baffle 43 away from the at least one waste tire 70. In such an arrangement, the at least one waste tire 70 will not break due to friction between the at least one water jet head 441 and the at least one waste tire 70.

With reference to FIGS. 1 and 14, after the at least one waste tire 70 is split, the platform 251 of the lifting apparatus 25 ascends to carry the split tire 70. The piston rod of the cylinder 314 retracts into the cylinder 314, such that the at least three claw mechanisms 323 pivot toward the central line C of the pushing rod 315 along the radial direction of the pushing rod 315 due to gravity. The platform 251 of the lifting apparatus 25 descends to place the split tire 70 onto the two conveyors 23 after the claws 327 of the at least three claw mechanisms 323 are not in contact with the inner periphery of the split tire 70. In the meanwhile, both the front door 21 and the back door 22 ascend. The two conveyors 23 transport the split tire 70 to the discharging device 25 while the feeding device 10 transports the tire 70 to be split into the water jet splitting chamber 20.

With the aforementioned technical characteristics, the water jet splitting machine for waste tires has the following advantages.

1. The present invention includes the feeding device 10, the water jet splitting chamber 20, the waste tire controlling device 30, the water jet device 40, and the discharging device 50. With such a configuration, all the user has to do is to place the at least one waste tire 70 onto the feeding device 10, and the present invention starts to process the at least one waste tire 70 automatically. After the at least one waste tire 70 is split, the discharging device 50 transports the at least one waste tire 70 out of the water jet splitting chamber 20. Compared with the conventional water jet splitting machine for waste tires with low degree of automation, the present invention has higher degree of automation, such that the present invention works at higher efficiency and ensures the safety of workers.

2. Having the linear moving device 41 and the linear displacement device 42, a position of the water jet seat 44 is adjustable and the water jet seat 44 splits the at least one waste tire 70 at a proper position with the at least one water jet head 441.

3. The water jet device 40 has the tread sensing rod 45, and the abutting portion 451 of the tread sensing rod 45 extends farther than the at least one water jet head 441. When the sensing rod 45 is moved toward the at least one waste tire 70 by the linear displacement device 42 until the abutting portion 451 of the tread sensing rod 45 is pushed by the at least one waste tire 70 and the cam 452 contacts the micro switch 47, the micro switch 47 emits the signal making the linear displacement device 42 move the water baffle 43 away from the at least one waste tire 70 to protect the at least one water jet head 441 from breaking.

4. The control console 60 is electrically connected to the driving assembly 31 of the waste tire controlling device 30, the linear moving device 41, and the linear displacement device 42, so the user can input size data of the at least one waste tire 70 into the control console 60 to control movements of the above-mentioned components. The claw 327 of one of the at least three claw mechanisms 323 can pivot to support the inner periphery of the at least one waste tire 70 according to the inner diameter of the at least one waste tire 70 inputted by the user. The linear moving device 41 and the linear displacement device 42 can move the water jet seat 40 to a proper position for the water jet seat 44 to split the at least one waste tire 70 according to the thickness and the outer diameter of the at least one waste tire 70. Therefore, the present invention is suitable for tires 70 of different sizes.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A water jet splitting machine for waste tires utilized to split at least one waste tire, the water jet splitting machine comprising:
a feeding device;
a water jet splitting chamber disposed beside the feeding device;
a waste tire controlling device disposed on a top of the water jet splitting chamber and having
a central line;
a claw assembly disposed in the water jet splitting chamber and having
at least three claw mechanisms, each one of the at least three claw mechanisms having
a claw capable of moving away from the central line along a radial direction, such that the claws of the at least three claw mechanisms support an inner periphery of the at least one waste tire together; and
a driving assembly mounted on the top of the water jet splitting chamber and having
a driver; and
a drive pulley spaced apart from the driver and mounted to the claw assembly, such that power is transmitted from the driver to the drive pulley and the drive pulley drives the claw assembly and the at least one waste tire to rotate;
a water jet device disposed beside the claw assembly of the waste tire controlling device and having
a water jet seat having
at least one water jet head capable of ejecting water toward the at least one waste tire; and
a discharging device disposed at one of two sides of the water jet splitting chamber away from the feeding device.

2. The water jet splitting machine as claimed in claim 1, wherein
the water jet device has a linear displacement device disposed beside the claw assembly; and
the water jet seat is connected to the linear displacement device, such that the linear displacement device is capable of moving the water jet seat toward the at least one waste tire and moving the water jet seat away from the at least one waste tire.

3. The water jet splitting machine as claimed in claim 2, wherein the water jet device has
a tread sensing rod capable of moving toward the claw assembly and moving away from the claw assembly, connected to the linear displacement device, and having
an abutting portion disposed at one of two ends of the tread sensing rod adjacent to the claw assembly and extending farther than the at least one water jet head; and
a cam protruding on an outer surface of the tread sensing rod radially and disposed away from the claw assembly; and
a micro switch connected to the linear displacement device;
when the abutting portion of the tread sensing rod is pushed by the at least one waste tire and moves away from the claw assembly, the cam of the tread sensing rod contacts the micro switch.

4. The water jet splitting machine as claimed in claim 3, wherein
the water jet device has a compression spring;
when the abutting portion of the tread sensing rod is pushed by the at least one waste tire, the compression spring is compressed;
when the abutting portion of the tread sensing rod is spaced apart from the at least one waste tire, the compression spring restores to its original length.

5. The water jet splitting machine as claimed in claim 2, wherein
the water jet device has
a linear moving device fixed in the water jet splitting chamber and disposed beside the claw assembly; and
a connecting base mounted to the linear moving device;
the linear displacement device is mounted to the connecting base; and
the linear moving device drives the linear displacement device and the connecting base to move upwardly and downwardly.

6. The water jet splitting machine as claimed in claim 3, wherein
the water jet device has
a linear moving device fixed in the water jet splitting chamber and disposed beside the claw assembly; and
a connecting base mounted to the linear moving device;
the linear displacement device is mounted to the connecting base; and
the linear moving device drives the linear displacement device and the connecting base to move upwardly and downwardly.

7. The water jet splitting machine as claimed in claim 4, wherein
the water jet device has
a linear moving device fixed in the water jet splitting chamber and disposed beside the claw assembly; and
a connecting base mounted to the linear moving device;
the linear displacement device is mounted to the connecting base; and
the linear moving device drives the linear displacement device and the connecting base to move upwardly and downwardly.

8. The water jet splitting machine as claimed in claim 3, wherein the water jet splitting machine comprises a control console electrically connected to the linear moving device and the micro switch.

9. The water jet splitting machine as claimed in claim 5, wherein the water jet splitting machine comprises a control console electrically connected to the linear displacement device, the linear moving device, and the micro switch.

10. The water jet splitting machine as claimed in claim 6, wherein the water jet splitting machine comprises a control console electrically connected to the linear displacement device, the linear moving device, and the micro switch.

11. The water jet splitting machine as claimed in claim 7, wherein the water jet splitting machine comprises a control console electrically connected to the linear displacement device, the linear moving device, and the micro switch.

12. The water jet splitting machine as claimed in claim 5, wherein the water jet splitting machine comprises a control console electrically connected to the driving assembly of the waste tire controlling device, the linear displacement device, the linear moving device, and the micro switch.

13. The water jet splitting machine as claimed in claim 6, wherein the water jet splitting machine comprises a control console electrically connected to the driving assembly of the waste tire controlling device, the linear displacement device, the linear moving device, and the micro switch.

14. The water jet splitting machine as claimed in claim 7, wherein the water jet splitting machine comprises a control console electrically connected to the driving assembly of the waste tire controlling device, the linear displacement device, the linear moving device, and the micro switch.
